(19) United States
(12) Patent Application Publication
(10) Pub. No.: US 2010/0256805 A1
(43) Pub. Date: Oct. 7, 2010

(54) Method for Aircraft Baggage Handling

(75) Inventors: Lothar Becker, Neunkirchen (DE); Jörn Brütt, Nurnberg (DE); Hermann Kirchberger, Igensdorf (DE); Heinz-Peter Peters, Roth-Pfaffenhofen (DE); Kai Ramadhin, Mt Alkmaar (NL); Walter Rosenbaum, Paris (FR)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/668,921

(22) PCT Filed: Jul. 11, 2008
(86) PCT No.: PCT/EP08/59097

§ 371 Date: Jun. 8, 2010

(30) Foreign Application Priority Data
Jul. 13, 2007 (DE) 10 2007 032 777.5

(51) Int. Cl. G06F 7/00; G06K 19/00

(52) U.S. Cl. 700/223; 235/375

(57) ABSTRACT

A method for handling aircraft baggage which is transported in an aircraft, preferably in standardized baggage containers, for the passengers of a specific flight in the arrival sector of an airport terminal, announces to the passenger that his or her item of baggage is being handled on one of the baggage carousels and simultaneously ensures that the item of baggage of a passenger or a plurality of items of baggage are actually available on the announced baggage carousels. In order to do so, the flight baggage is logistically associated with passenger-related criteria that are stored in a computer and that determine upon or after unloading of the aircraft or the baggage containers, the distribution of the flight baggage to one of a plurality of baggage carousels.

The invention relates to a method for handling the aircraft baggage which is transported in an aircraft, preferably in standardized baggage containers (ULD), for the passengers on a specific flight between two or more carousels in the arrival terminal of the airport terminal.

Many airports are currently experiencing a continuous increase in the number of passengers. The large number of people traveling by aircraft also makes it necessary, for economic and ecological reasons, however, to transport as many passengers as possible in one aircraft, and thus to increase the flight capacities. For this reason, new aircraft types have been developed in the recent past; currently, jumbo jets with a capacity of more than eight hundred passengers and aircraft for more than a thousand passengers are being planned. In order to allow these large aircraft as well as conventional aircraft types to be handled on the ground, numerous modern airport installations will have to be converted. Changes to the entire infrastructure, all the way from check-in to the ramp configuration, must be carried out.

One particular problem in conjunction with the described wide-body aircraft occurs after landing in the output of baggage to the flight passengers on the carousel in the airport arrival terminal. Specifically, because of the large number of baggage items, it is no longer possible, as in the past, to provide the baggage from an individual flight on just one carousel, and, instead of this, it is necessary to distribute these baggage items between two or more carousels. On the other hand, however, passengers cannot be expected to wait at a number of baggage carousels at the same time for the arrival of the baggage items, not least because the baggage carousels may be a long distance away from one another.

The present invention is based on the object of distributing the aircraft baggage, which is provided on more than one carousel, from one and the same flight such that the individual aircraft passenger is able to receive all of his aircraft baggage on just one carousel, which can be defined in advance.

The invention proposes that when the aircraft baggage is received at check-in or immediately after this, the aircraft baggage is logistically associated with passenger-related criteria, such as first class, economy class or business class, which criteria are stored in a computer, and proposes that the distribution of the aircraft baggage is carried out on the basis of the stored association to one of a plurality of carousels, during or after the unloading of the aircraft or the baggage containers, deliberately on the basis of reproducible criteria which are defined at the latest before the baggage item is passed to the respective carousel, and that, before the aircraft baggage is being loaded onto the carousels, or while this is being done, from one and the same flight, the passenger is informed of which carousel his aircraft baggage will be on. The logistic association is preferably created when the aircraft baggage is actually received at check-in or immediately after this. It is therefore possible to actually define the criteria which influence the location or the sequence of the output at the end of the flight, when the baggage is being received at the check-in counter.

The purpose of the invention is that the baggage will no longer arrive randomly and in a random sequence on the carousels in the reclaim area at the airport, but that the distribution between the carousels will be carried out deliberately on the basis of previously defined, reproducible criteria defined at the latest before the baggage item is passed to the respective carousel. Only if a logistic association is carried out and the distribution of the baggage items between defined carousels is defined on the basis of this logistic association is it possible to notify the aircraft passenger of one of the carousels on which his baggage item will be provided, and at the same time to ensure that the baggage item, or items if one aircraft passenger has more than one baggage item, will actually be available on the notified carousel.

1-15. (canceled)

16. A method for handling aircraft baggage transported in an aircraft, individually or in standardized baggage containers, between two or more carousels in an arrivals terminal of an airport terminal, for passengers of a specific flight, the method comprising the following steps:
logistically associating the aircraft baggage with passenger-related criteria stored in a computer, upon receiving the aircraft baggage at check-in or immediately thereafter;
distributing the aircraft baggage, based on the stored association, to one of a plurality of carousels, during or after unloading of the aircraft or the baggage containers, deliberately based on reproducible criteria defined at the latest before the baggage item is passed to a respective carousel; and
informing the passenger which carousel will handle the passenger's aircraft baggage, before or during loading of the aircraft baggage onto the carousels from one and the same flight.

17. The method according to claim 16, wherein the passenger-related criteria are first class, economy class and business class.

18. The method according to claim 16, which further comprises taking a number of aircraft baggage items which can be handled or are contained in a baggage container into account during the step of logistically associating the aircraft baggage.

19. The method according to claim 16, which further comprises taking a reception of a plurality of baggage items of one passenger, or of a jointly traveling passenger, at check-in into account during the step of logistically associating the aircraft baggage.

20. The method according to claim 16, which further comprises taking at least one of a seat location of the passenger or a seat location arrangement in an aircraft into account as a passenger-related criterion, during the step of logistically associating the aircraft baggage.

21. The method according to claim 16, which further comprises providing the passenger with information about an output location of the passenger's aircraft baggage during a flight or during a landing approach.

22. The method according to claim 21, which further comprises providing the information by a video system associated with each seat location.

23. The method according to claim 21, which further comprises providing the information by an indicator board provided on the ground.

24. The method according to claim 23, which further comprises outputting a name of the passenger or a previously defined keyword on the indicator board.

25. The method according to claim 23, which further comprises providing the information based on a passenger seat location number associated with the respective carousel.

26. The method according to claim 23, which further comprises providing the information on a data storage medium for input by the passenger into a reader indicating a relevant carousel.

27. The method according to claim 26, which further comprises using a section of a flight ticket as the data storage medium.

28. The method according to claim 16, which further comprises using an initial letter of a surname of a traveling passenger for the logistic association with the aircraft baggage.
